(19) United States
(12) Patent Application Publication
(10) Pub. No.: US 2020/0228058 A1
(43) Pub. Date: Jul. 16, 2020

(54) CONCENTRATED MULTIFUNCTIONAL SOLAR SYSTEM

(71) Applicant: BOLYMEDIA HOLDINGS CO. LTD., Santa Clara, CA (US)

(72) Inventor: Xiaoping HU, Shenzhen (CN)

(73) Assignee: BOLYMEDIA HOLDINGS CO. LTD., Santa Clara, CA (US)

(21) Appl. No.: 16/615,756

(22) PCT Filed: May 26, 2017
(86) PCT No.: PCT/CN2017/086103

§ 371 Date: Nov. 21, 2019

(51) Int. Cl. H02S 40/22; H02S 40/42; H02S 10/30; F24S 23/30; F24S 23/00

(52) U.S. Cl. CPC H02S 40/22; H02S 40/425; G02B 3/08; F24S 23/31; F24S 23/12; H02S 10/30

(57) ABSTRACT

A concentrated multifunctional solar energy system, comprising a concentrating-form layer (110) containing a Fresnel concentrated device (111), a light-guiding-form layer (120) containing a light-guiding tube (121), at least one light-energy utilizing device (130), and a bottom tray (140). The light-energy utilizing device (130) is disposed at the bottom of the light-guiding tube (121), or disposed in the light-guiding tube (121); the periphery (122) of the light-guiding-form layer (120) is closely matched with the periphery (112) of the concentrating-form layer (110) and the periphery (141) of the bottom tray (140) separately so as to form closed first and second spaces; the second space accommodates a working substance (142) in thermal conductive connection with a photoelectric conversion device in the light-energy utilizing device (130); the electrical utilization and thermal utilization of the light energy are respectively achieved by means of the two closed spaces.

### TECHNICAL FIELD

The present disclosure relates to clean energy, and in particular to concentrated multifunctional solar systems.

### BACKGROUND OF THE INVENTION

With increasing focus on environmental protection, solar energy systems are growing in popularity. Available solar systems which usually have sole function generally includes: generating power directly with a photovoltaic conversion device, generating power with a thermal energy generator that uses thermal energy converted from solar energy, and directly utilizing heat from solar energy. However, power and heat (such a as hot water and heating) are simultaneously desired in most applications.

In addition, the systems for utilizing heat from solar energy, including vacuum-tube solar water heating system, are generally quite large in volume, difficult and potentially risky in installation and usage, leading to uneasy popularization in various applications. Therefore, it is necessary to study a compact and versatile solar system.

### SUMMARY OF THE INVENTION

A concentrated multifunctional solar system according to the present disclosure may include a concentrating-form layer, a light-guiding-form layer, a bottom tray and at least one light-energy utilizing device. The concentrating-form layer may include at least one Fresnel concentrated device, and each Fresnel concentrated device includes a concentrating Fresnel lens. The light-guiding-form layer is arranged under the concentrating-form layer and includes at least one reflective light-guiding tube, wherein the light-guiding tube has at least a reflective mirror as part of its inner wall, a bigger top opening and a smaller bottom opening, the light concentrated by the Fresnel concentrated device is incident from the top of the light-guiding tube. The bottom tray is arranged under the light-guiding-form layer. The light-energy utilizing device is arranged at the bottom of the light-guiding tube or in the light-guiding tube, and may include a photovoltaic conversion device. The periphery of the concentrating-form layer closely matches the periphery or top of the light-guiding-form layer such that a closed first space is formed therebetween, and the periphery of the light-guiding-form layer closely matches the periphery of the bottom tray such that a closed second space is formed therebetween. The second space can accommodate working substance thermally connected to the photovoltaic conversion device.

With the concentrating multifunctional solar system according to the present disclosure, the electrical utilization and thermal utilization of the light energy can be respectively achieved by means of the two closed spaces, and the system can have a compact structure to satisfy the installation requirements of different environments. And because of the Fresnel concentrated device, the sunlight is concentrated from the larger light-receiving surface to the smaller light-energy utilizing device, improving the concentration ratio for further heat utilization and reducing the overall height of the system. In addition, the thermally conductive connection of the working substance for thermal utilization to the photoelectric conversion device enables not only the temperature of the photoelectric conversion device to be lowered, but also the working efficiency and the service life thereof, and the energy that is not converted into electric energy can be continued as heat energy, improving the overall utilization efficiency of solar energy.

Specific examples according to the present disclosure are described in detail below with reference to the accompanying drawings. As used herein, terms that indicate a position, such as “upper”, “lower”, “top”, “bottom” and the like, only refer to relative positional relationships, having no absolute meanings. The serial numbers or sequence numbers used herein, such as “first”, “second”, etc., are merely illustrative without any restrictive meanings.

### BRIEF DESCRIPTION OF THE DRAWINGS

FIG. 1 is a schematic view of a concentrating multi-function solar energy system of Embodiment 1;

FIG. 2 is a schematic view of a light-guiding tube having a hexagonal cross section filled with an optical gas in the present disclosure;

FIG. 3 is a schematic view of a composite light-energy utilizing device in the present disclosure;

FIG. 4 is a schematic view of a preferred Fresnel concentrated device in the present disclosure;

FIG. 5 is a schematic view of a closed light-energy utilizing device in the present disclosure;

FIG. 6 is a schematic view of a concentrating multi-function solar energy system of Embodiment 2;

FIG. 7 is a schematic view of a concentrating multi-function solar energy system of Embodiment 3.

### DETAILED DESCRIPTION

### Embodiment 1

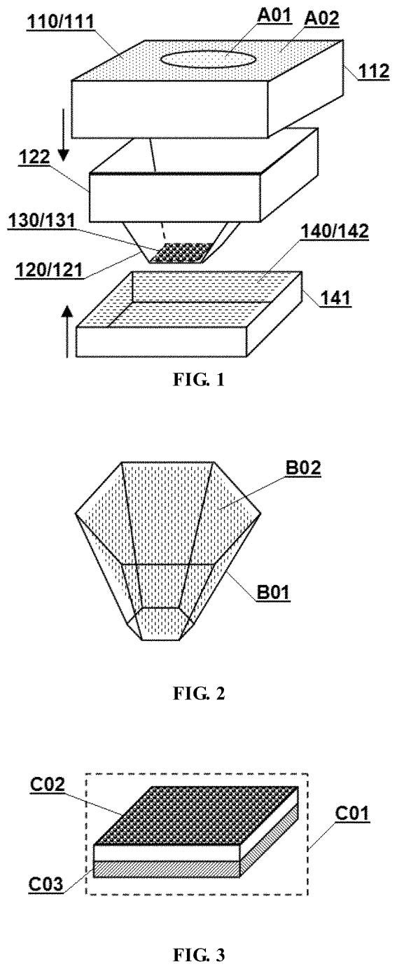

Referring to FIG. 1, a concentrated multifunctional solar system according to one embodiment of the present disclosure is schematically shown in structure after being longitudinally decomposed. The present system may include a concentrating-form layer 110, a light-guiding-form layer 120, a light-energy utilizing device 130 and a bottom tray 140.

The concentrating-form layer 110 may include one Fresnel concentrated device. In this embodiment, the Fresnel concentrated device is made up of a concentrating Fresnel lens 111. In other embodiment, the concentrating-form layer may also include a plurality of Fresnel concentrated devices which may for example be arranged in an array structure to form the entire concentrating-form layer. Each condensing device may further include more optical components to obtain a desired concentrating effect. Besides the components for optical operation, the concentrating-form layer may also have a peripheral configuration for connecting with other components. The specific structure and shape of the configuration can be designed according to the needs of actual applications, as long as required connection thereof can be achieved. Illustratively, the concentrating-form layer has a straight-cylindrical peripheral structure 112 in this embodiment.

The light-guiding-form layer 120 is arranged under the concentrating-form layer 110, and includes a reflective light-guiding tube 121 having at least a reflective mirror as part of its inner wall. The top opening of the light-guiding tube is relatively big and the bottom opening is relatively small. The light concentrated by the Fresnel concentrated device is incident from the top of the light-guiding tube. The light-guiding tube has a corresponding relationship with the condensing device; in another embodiment, when the concentrating-form layer has a plurality of condensing devices, the light-guiding-form layer may also include a plurality of light-guiding tubes correspondingly, for example an array structure arranged similar to the condensing devices. For ease of fabrication or integration into an array structure, the cross-sectional shape of the light-guiding tube can be selected from the group consisting of quadrilateral, hexagonal, circular, and the like. The cross-sectional shape of the light-guiding tube in this embodiment is quadrangular. The light-guiding-form layer may also have a peripheral structure used for connecting with other components, such as a straight-cylindrical brim 122 shown in FIG. 1. When the light-guiding-form layer is of an array structure made up of a plurality of light-guiding tubes, the brim can surround the periphery of the array structure of the light-guiding tubes.

The periphery of the concentrating-form layer may be closely fitted to the periphery or top of the light-guiding-form layer such that a closed first space is formed therebetween. For this purpose, the Fresnel lens 111 is preferably formed as a top surface of the concentrating-form layer (or at least a portion of the top surface) to help to form the first space. Illustratively, by the straight-cylindrical brim 122, the light-guiding-form layer is closely nested with the straight-cylindrical peripheral structure 112 of the concentrating-form layer in this embodiment. The closure of the first space helps to keep it clean to ensure the efficiency and service life of every related components. The first space can be filled with air or an inert gas, or it can be evacuated. As a preferred embodiment, the first space may be filled with a gas having a refractive index greater than 1 to further increase the concentration ratio. Gases having a refractive index greater than 1 may include an optical gas and a high pressure gas having a pressure greater than atmospheric pressure. The term “optical gas” refers to a gas whose refractive index is greater than the refractive index of air under identical physical conditions, and the identical physical conditions refer to identical temperature and identical pressure. As shown in FIG. 2, the light-guiding tube B01 having a hexagonal cross section is filled with a gas B02 having a refractive index greater than 1.

The light-energy utilizing device 130 is arranged at the bottom of the light-guiding tube 121 such that the bottom of the light-guiding tube is closed. In this embodiment, the light-energy utilizing device is a photovoltaic conversion device, such as a photovoltaic panel, a photovoltaic film, or a quantum dot photovoltaic material made of various materials (which is described as “photovoltaic panel” hereinafter for the sake of brevity). A single-sided light-receiving photovoltaic panel 131 is used in this embodiment, the light-receiving side facing toward the top of the light-guiding tube. In another embodiment, a double-sided light-receiving photovoltaic panel may be employed, arranged in the light-guiding tube and fixed on the light-guiding tube by a heat-conducting support; in this case the bottom of the light-guiding tube can be enclosed by the reflective mirror. In other embodiments, when there are multiple light-guiding tubes, multiple light-energy utilizing devices may be provided accordingly. Furthermore, as a preferred embodiment, the light-energy utilizing device may also be combinational, that is, it further includes a thermoelectric conversion device besides the photovoltaic panel. The thermoelectric conversion device may be arranged on the heat conduction path of the photovoltaic panel to radiate outward (for example, close to the back side of the photovoltaic panel) to further convert thermal energy into electrical energy during the heat dissipation of the photovoltaic panel. The thermoelectric conversion device can be, for example, a semiconductor device having a thermoelectric effect. FIG. 3 shows an example of a combinational light-energy utilizing device C01 having both a photovoltaic panel C02 and a thermoelectric conversion device C03.

The bottom tray 140 is arranged below the light-guiding-form layer 120, exemplarily having a straight-cylindrical peripheral structure 141. The periphery of the light-guiding-form layer closely matches the periphery of the bottom tray, so that a closed second space is formed therebetween. Illustratively, the light-guiding-form layer is closely nested with the straight-cylindrical peripheral structure 141 of the concentrating-form layer through the straight-cylindrical brim 122 in this embodiment.

Working substance 142 thermally connected to the photovoltaic panel 131 is accommodated in the second space. Specifically, the back side of the photovoltaic panel 131 may be immersed in the working substance 142. The working substance may preferably be a substance having a large heat capacity, which may be a solid or a liquid, and the heat absorbed by the working substance may be supplied to the outside by further heat conduction or by circulation through the working substance. The working substance of liquid may, for example, be selected from at least one of the group consisting of water, coolant, oil, and refrigerant. In this case, the bottom tray may be further provided with an inlet and an outlet for the inflow and outflow of the working substance. The circulation system of the liquid working substance can be either open or closed, and can be determined according to the type of working substance and a desired form of thermal energy utilization.

The condensing device in the present disclosure may employ a Fresnel lens which is thin and easy to be mass-produced. As used herein, a “concentrating” (or “astigmatic”) Fresnel lens may refer to a Fresnel lens having a tooth surface from a convex lens surface (or a concave lens surface). A “linear” Fresnel lens, including a linear astigmatic Fresnel lens and a linear concentrating Fresnel lens, may means that the focus center of the lens is a line instead of being concentrated at one point. For example, the tooth surface of a linear Fresnel lens may be from a concave (or convex) cylindrical surface, or a concave (or convex) polynomial cylinder. Each tooth surface of each Fresnel lens may be either a simple lens face containing only one Fresnel unit or a composite lens face composed of a plurality of Fresnel units.

The concentrating Fresnel lens 111 in this embodiment (as a preferred embodiment) is divided into different regions according to the distance from the central optical axis thereof, for example, the central region A01 and the peripheral region A02 shown in FIG. 1. The region farther from the central optical axis (i.e. the peripheral region A02) has a shorter focal length, while the region closer to the central optical axis (i.e. the central region A01) has a longer focal length. In this respect, it allows the concentrated light to be more evenly distributed on the surface of the photovoltaic panel, facilitating balanced energy conversion and heat dissipation.

In a further preferred embodiment, the Fresnel concentrated device may further include a first astigmatic Fresnel lens arranged uprightly below the concentrating Fresnel lens for deflecting the incident light downward. More preferably, the Fresnel concentrated device may further include a second astigmatic Fresnel lens arranged uprightly below the concentrating Fresnel lens and crossing the first astigmatic Fresnel lens for deflecting the incident light downward. FIG. 4 shows a preferred Fresnel concentrated device comprising a concentrating Fresnel lens D01 having two regions of different focal lengths, a first astigmatic Fresnel lens D02, a second astigmatic Fresnel lens D03 and a straight-cylindrical peripheral structure D04. The condensing device of FIG. 4 is good at providing a high concentrating ratio; moreover, it can adapt to the displacement of the sun in the east-west and north-south directions without using a sun-tracking system due to the two upright astigmatic lenses.

The concentrating Fresnel lens and the first and second astigmatic Fresnel lenses may each be a linear Fresnel lens. The focus central line of each linear Fresnel lens may be substantially parallel to the bottom of the light-guiding tube, for example to the surface of the photovoltaic panel, such that the concentrated sunlight can be evenly distributed on the surface of the photovoltaic panel as much as possible.

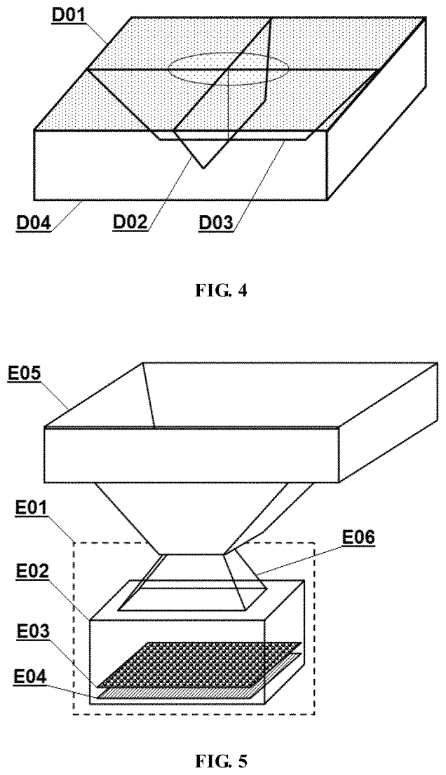

In an alternative embodiment, the light-energy utilizing device may have an auxiliary structure in addition to one or more energy conversion devices. For example, the light-energy utilizing device may further comprise a closed container having at least a reflective mirror as part of its inner wall. The bottom of the light-guiding tube of the light-guiding-form layer is in a butt joint with the inlet of the closed container, and the photovoltaic panel may be arranged at the inner wall of the closed container or arranged in the closed container. Preferably, the portion of the closed container that is located around the inlet can be formed into a tapered shape with a smaller top opening and a larger bottom opening, which makes it difficult for light entered the closed container to be reflected again. FIG. 5 shows a closed light-energy utilizing device E01 comprising a closed container E02, a photovoltaic panel E03 and a thermoelectric conversion device E04. The inner wall of the closed container E02 is a reflective mirror, and the inlet is in a butt joint with the bottom of the light-guiding tube E05. The inlet portion E06 of the closed container forms an inverted conical shape to prevent light from escaping. The photovoltaic panel and the thermoelectric conversion device are stacked on the bottom of the closed container, exchanging heat with the outside through the bottom.

### Embodiment 2

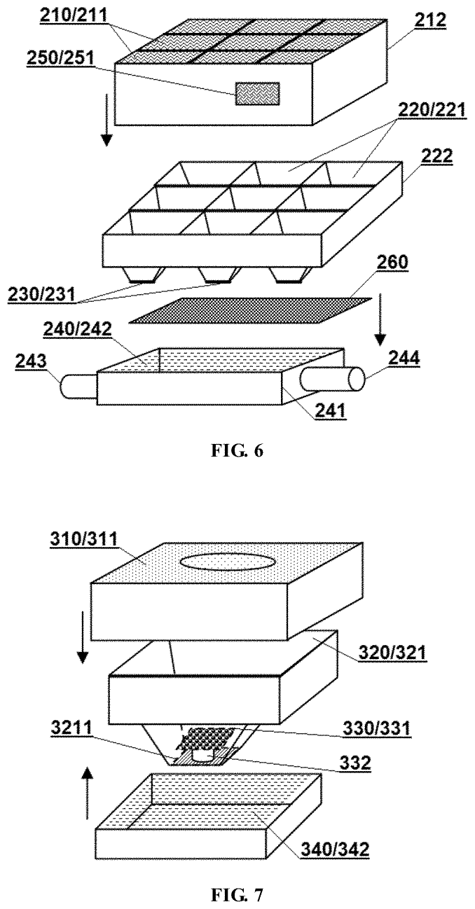

Referring to FIG. 6, a concentrated multifunctional solar system according to another embodiment of the present disclosure is schematically shown in structure after being longitudinally decomposed. The present system may include a concentrating-form layer 210, a light-guiding-form layer 220, a light-energy utilizing device 230, and a bottom tray 240.

Similar to Embodiment 1, the light-guiding-form layer 220 has a straight-cylindrical brim 222, and the concentrating-form layer 210 and the bottom tray 240 respectively have straight-cylindrical peripheral structures 212, 241 adapted to the shape thereof correspondingly, such that after assembly, a closed first space is formed between the concentrating-form layer 210 and the light-guiding-form layer 220 and a closed second space is formed between the light-guiding-form layer 220 and the bottom tray 240. The liquid working substance 242 is housed in the second space.

This embodiment is mainly different from Embodiment 1 in that:

1. The light-guiding-form layer 220 includes an array structure arranged by a plurality of quadrilateral light-guiding tubes 221. Accordingly, the light-energy utilizing device 230 includes a plurality of photovoltaic panels 231 arranged at the bottom of the light-guiding tube 221 respectively. Similarly, the concentrating-form layer is also divided into a plurality of Fresnel concentrated devices (i.e., concentrating Fresnel lenses 211) arranged in an array. It should be noted that although the top of the concentrating-form layer is divided into a plurality of condensing devices according to the correspondence relationship with each light-guiding tube, it can actually be represented as a whole. Each concentrating Fresnel lens 211 may be a simple Fresnel lens containing only one Fresnel unit, or may be a composite Fresnel lens containing a plurality of Fresnel units (for example, the Fresnel lens having two regions of different focal lengths in Embodiment 1). Furthermore, each condensing device may further comprise more optical elements, for example the structure shown in FIG. 4 may preferably be employed.

2. A piezoelectric vibrator 250 is also provided which includes a piezoelectric vibrating piece 251 and its driving circuit (not shown). The piezoelectric vibrating piece 251 is fixed to the outside of the straight-cylindrical peripheral structure 212 of the concentrating-form layer 210, driving the condensing device to vibrate to, for example, automatically clean the light-receiving surface of the condensing device, or remove snow, device and the like. In other embodiments, the piezoelectric vibrating piece may be fixed at other positions, such as the inner side of the brim 222, as long as it can be mechanically coupled to the concentrating-form layer or the light-guiding-form layer to cause it to vibrate.

3. A metal heat sink 260 (or a thermal-conducting element) is also provided, arranged outside the bottom of the light-guiding tube. On the one hand, the metal heat sink 260 can accelerate the heat dissipation speed of the photovoltaic panel 231. On the other hand, when the liquid working substance 242 is dried inadvertently, the heat sink can also function to limit the maximum temperature of the system to ensure safety. In other embodiments, the heat sink or the thermal-conducting element may be arranged on other position at the outside of the light-guiding tube as long as it is in thermal contact with the photovoltaic panel or in a position adjacent to the photovoltaic panel that can be thermally conductive to the photovoltaic panel.

4. The bottom tray 240 may be further provided with an inlet 243 and an outlet 244 for the inflow and outflow of the working substance 242 so as to exchange heat or perform thermal energy utilization with an external thermal-utilizing device.

### Embodiment 3

Referring to FIG. 7, a concentrated multifunctional solar system according to still another embodiment of the present disclosure is schematically shown in structure after being longitudinally decomposed. The present system may include a concentrating-form layer 310 having a composite Fresnel lens 311, a light-guiding-form layer 320 having a light-guiding tube 321, a light-energy utilizing device 330 and a bottom tray 340 holding a working substance 342.

The description of the concentrating-form layer 310, the light-guiding-form layer 320 and the bottom tray 340 and the structural relationship thereof are similar to those in Embodiment 1, which will not be repeated herein.

This embodiment is primarily different from the aforesaid embodiments in that: the photovoltaic panels in the aforesaid embodiments are arranged at the bottom of the light-guiding tube; while the light-energy utilizing device (i.e. the photovoltaic panel 331) in this embodiment is arranged in the light-guiding tube 321 and fixed on the light-guiding tube by a thermal-conducting support 332, and the bottom of the light-guiding tube is enclosed by a reflective mirror 3211. In this case, the photovoltaic panel 331 may preferably employ a double-sided light-receiving photovoltaic panel to improve light energy utilization.

To facilitate heat exchange with the working substance in the bottom tray, the support 332 may be a metal support rod or a hollow support rod, and the inside thereof is in communication with the working substance in the bottom tray.

The principle and implementation manners present disclosure have been described above with reference to the specific examples, which are merely provided for the purpose of understanding the present disclosure and are not intended to limit the present disclosure. It will be possible for those skilled in the art to make variations based on the principle of the present disclosure.

1. A concentrated multifunctional solar system, comprising:
a concentrating-form layer containing at least one Fresnel concentrated device, each Fresnel concentrated device comprising a concentrating Fresnel lens,
a light-guiding-form layer arranged under the concentrating-form layer and containing at least one reflective light-guiding tube, wherein the light-guiding tube has at least a reflective mirror as part of its inner wall, a bigger top opening and a smaller bottom opening, the light concentrated by the Fresnel concentrated device is incident from the top of the light-guiding tube;
at least one light-energy utilizing device arranged at the bottom of the light-guiding tube or in the light-guiding tube, and containing a photovoltaic conversion device; and
a bottom tray arranged under the light-guiding-form layer;
wherein the periphery of the concentrating-form layer is closely matched with the periphery or top of the light-guiding-form layer so as to form a closed first space therebetween;
the periphery of the light-guiding-form layer is closely matched with the periphery of the bottom tray so as to form a closed second space therebetween;
the second space accommodates a working substance in thermal conductive connection with the photovoltaic conversion device; and
wherein a straight-cylindrical brim is arranged at the periphery of the light-guiding-form layer,
the periphery of the concentrating-form layer and the periphery of the bottom tray match with the brim in shape such that the brim can be nested with the periphery of the concentrating-form layer and the periphery of the bottom tray.

2. The system according to claim 1, wherein
the first space is filled with a gas having a refractive index greater than 1.

3. The system according to claim 1, wherein
the working substance is liquid selected from at least one of the group consisting of water, a coolant, an oil and a refrigerant, and
the bottom tray is further provided with an inlet and an outlet for the inflow and outflow of the working substance.

4. (canceled)

5. The system according to claim 1, wherein
the concentrating-form layer comprises a plurality of Fresnel concentrated devices arranged in an array; and
the light-guiding-form layer comprises a plurality of light-guiding tubes arranged in an array, each light-guiding tube corresponds to respective Fresnel concentrated device, the cross-sectional shape of the light-guiding tube is selected from the group consisting of quadrilateral, hexagonal and circular, and the brim is surrounded the periphery of the array of the light-guiding tubes.

6. The system according to claim 1, wherein
the concentrating Fresnel lens forms to be at least a part of the top surface of the concentrating-form layer.

7. The system according to claim 6, wherein
the Fresnel concentrated device further comprises a first astigmatic Fresnel lens arranged uprightly below the concentrating Fresnel lens for deflecting the incident light downward.

8. The system according to claim 7, wherein
the Fresnel concentrated device further comprises a second astigmatic Fresnel lens arranged uprightly below the concentrating Fresnel lens and crossing over the first astigmatic Fresnel lens for deflecting the incident light downward.

9. The system according to claim 8, wherein the system has at least one of the following features:
the concentrating Fresnel lens is a linear concentrating Fresnel lens; and
the first and second astigmatic Fresnel lenses are linear astigmatic Fresnel lenses.

10. The system according to claim 1, wherein
the concentrating Fresnel lens is divided into different regions according to the distance from the central optical axis thereof, the region farther from the central optical axis having a shorter focal length and the region closer to the central optical axis having a longer focal length.

11. The system according to claim 1, wherein
the photovoltaic conversion device is a single-sided light-receiving photovoltaic panel arranged at the bottom of the light-guiding tube, the light-receiving side facing toward the top of the light-guiding tube; or
the photovoltaic conversion device is a double-sided light-receiving photovoltaic panel arranged in the light-guiding tube and fixed on the light-guiding tube through a heat-conducting support, the bottom of the light-guiding tube is closed by a reflective mirror; or
the light-energy utilizing device further comprises a closed container having at least a reflective mirror as part of its inner wall, the bottom of the light-guiding tube is in a butt joint with the inlet of the closed container, and the photovoltaic conversion device is arranged on the inner wall of the closed container or in the closed container.

12. The system according to claim 11, wherein the portion of the closed container that is located around the inlet is formed into a tapered shape with a smaller top opening and a larger bottom opening.

13. The system according to claim 1, wherein the light-energy utilizing device further comprises a thermoelectric conversion device arranged on the heat conduction path of the photovoltaic conversion device and the working substance.

14. The system according to claim 1, further comprising
a piezoelectric vibrator having a piezoelectric vibrating piece and a driving circuit thereof, wherein the piezoelectric vibrating piece is mechanically coupled to the concentrating-form layer or the light-guiding-form layer to cause it to vibrate.

15. The system according to claim 1, further comprising
a metal heat sink or a thermal-conducting element arranged outside the light-guiding tube and coupled to the photovoltaic conversion device or located at a position adjacent to the photovoltaic conversion device that can be thermally conductive to the photovoltaic conversion device.
